(19) United States
(12) Patent Application Publication
(10) Pub. No.: US 2002/0052802 A1
(43) Pub. Date: May 2, 2002

(54) System and method for brokering wood products

(75) Inventors: Thomas J. Westbrook, Olympia, WA (US); Claudia J. Westbrook, Olympia, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: World Wide Wood Network, Ltd.

(21) Appl. No.: 10/001,556

(22) Filed: Oct. 31, 2001

Related U.S. Application Data
(60) Provisional application No. 60/244,821, filed on Oct. 31, 2000.

(51) Int. Cl. G06F 17/60

(52) U.S. Cl. 705/26; 705/28

(57) ABSTRACT

A system and method for facilitating wood product transactions are provided. A transaction processing server obtains a request for transaction partners and generates a list of available sellers. The transaction processing server obtains a selection of transaction partners and initiates negotiations between the parties, either through the transaction processing system or through direct communication channels. Upon obtaining confirmation of the completion of a transaction, the transaction processing server generates confirmation/transaction records and can process any additional third-party transactions relating to the original wood product transaction.

### CROSS-REFERENCE TO RELATED APPLICATION

This application claims the benefit of U.S. Provisional Application No. 60/244,821 entitled SYSTEM AND METHOD FOR BROKERING WOOD PRODUCTS, filed on Oct. 31, 2000. U.S. Provisional Application No. 60/244,821 is incorporated by reference herein.

### FIELD OF THE INVENTION

In general, the present invention relates to computer software and communication networks, and in particular, to a system and method for facilitating wood product transactions between buyers and sellers.

### BACKGROUND OF THE INVENTION

Traditional wood product transactions have a long-standing history in the wood products industry. Generally described, the traditional wood product transaction can involve direct interaction between a number of individual buyers and sellers. For example, if a buyer wishes to purchase wood products, the potential buyer is often required to personally contact each potential seller and negotiate terms. Similarly, if a seller wishes to sell wood products, the potential seller is often required to contact, either directly or indirectly, each potential buyer to initiate a sale. In a traditional embodiment, the buyer and seller communicate by utilizing a common telephone communication network.

One skilled in the relevant art will appreciate, however, that the traditional approach to conducting wood products transactions can be deficient for a number of reasons. In one aspect, requiring a buyer to directly contact each potential seller requires a significant investment of time for the buyer. Because the buyer must personally contact and negotiate with each potential seller, the buyer can devote time and resources negotiating with parties in which a transaction cannot, or will not, occur. Accordingly, in a time-critical transaction, a buyer may have a limited amount of time to contact sellers, unnecessarily including some potential sellers and unnecessarily excluding other potential sellers.

In another aspect, directly contacting each potential seller can exclude a number of potential sellers. For example, a buyer often will not directly contact a seller he or she is not familiar with. Accordingly, a number of potential sellers may be unnecessarily excluded because the buyer is not aware of the products/services offered by the potential seller or because the buyer is not familiar with the potential seller's agent.

In still another aspect, direct negotiation with individual seller's agents can create confusion and inefficiencies if multiple orders are placed with the same seller, but with different seller agents. For example, a buyer may have to deal with a first seller's agent to purchase a first product and another seller's agent to purchase a second product. Unless the two seller's agents coordinate, the buyer can experience differences in relation to order processing and often misses opportunities to consolidate shipping costs. Moreover, in some embodiments, each seller agent may have unique product and quantity identifiers, making integration more difficult.

In addition to the deficiencies associated with identifying the parties of a relationship, the traditional wood products transaction also has deficiencies associated with the negotiation and processing of transactions between the parties. In one aspect, each party may have specific terminology that they utilize to identify and process inventory. Moreover, sellers may also have unique packaging and shipping requirements as to how product is shipped. For example, a seller may implement a minimum number of board feet of lumber that must be purchased prior to completing a transaction. Accordingly, because each seller may implement different terminology and/or restrictions, negotiation between two parties can lead to inefficiencies in communication and/or errors in negotiating terms. In another aspect, processing of a wood products transaction can often involve any number of third-party providers to complete the transaction. For example, a buyer may contract with a shipping agent, a shipping broker, an insurance agent, and a warehouse agent to complete a single transaction. Because the relationships with the third-party providers require direct contact with the buyer/seller, the inefficiencies described above can be repeated for each of the third party providers.

The development of computing devices, such as personal computers, mobile phones, personal digital assistants, provides a new medium for establishing communication between parties. In a particularly common embodiment, a number of commerce services utilize the Internet, a vast number of computers often referred to as the “Web” or “World Wide Web,” to establish communication. Such communication network services are generally referred to as Web-based services. Many Web-based services interact with a potential consumer by presenting the consumer with one or more interactive displays, generally referred to as Web sites, to transact business by allowing the user to make purchases, modifications, inquiries, etc. By interacting with the Web site, such as by entering data through a keyboard, or by selecting graphically presented criteria, a consumer can manipulate the computer and Web site to accomplish various commerce-related tasks.

Although the utilization of computing device networks, such as the Internet, can mitigate some of the deficiencies associated with traditional in-person wood products transactions, the conventional Web-based buyer/seller network can become deficient when applied generically to the wood products fields. In one aspect, traditional Web-based buyer/seller networks do not provide easy integration for different product nomenclature between different buyers and different sellers. In another aspect, the conventional Web-based buyer/seller network does not provide for rules-based exclusions that maintain the ability for a buyer/seller to select transaction partners. In a further aspect, the conventional Web-based buyer/seller network does not typically provide for inclusion of third parties, such as shippers, insurers, as part of an integrated transaction. In still another aspect, the conventional Web-based buyer/seller network does not typically provide complementary communication channels to maintain buyer/seller contacts. In still a further aspect, the conventional Web-based buyer/seller network does not typically facilitate consolidation of product delivery for a buyer between the same and different sellers.

Thus, there is a need for a system and method for facilitating wood product transactions. More specifically, there is a need for a system and method for utilizing computerized communication networks configured to facilitate the transaction requirements in the wood products field.

### SUMMARY OF THE INVENTION

A system and method for facilitating wood product transactions are provided. A transaction processing server obtains a request for transaction partners and generates a list of available sellers. The transaction processing server obtains a selection of transaction partners and initiates negotiations between the parties, either through the transaction processing system or through direct communication channels. Upon obtaining confirmation of the completion of a transaction, the transaction processing server generates confirmation/transaction records and can process any additional third-party transactions relating to the original wood product transaction.

In accordance with an aspect of the present invention, a method for facilitating transactions between one or more buyers and sellers is provided. A transaction processing server obtains a buyer transaction request that includes one or more buyer criteria. The transaction processing server identifies a set of sellers corresponding to the buyer criteria and transmits the set of sellers. The transaction processing server obtains a selection of at least one seller corresponding to the buyer criteria and processes the negotiation of a transaction between the buyer and the selected seller corresponding to the buyer criteria. The transaction processing server then obtains a confirmation of the completion of a transaction between the buyer and the selected seller and generates transaction records associated with the completed transaction.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a representative portion of the Internet;

FIG. 2 is a block diagram of a wood products transaction system formed in accordance with the present invention;

FIG. 3 is a block diagram depicting an illustrative architecture for a buyer/seller computing device in accordance with the present invention;

FIG. 4 is a block diagram depicting an illustrative architecture for a transaction processing server in accordance with the present invention;

FIG. 5 is a block diagram of the wood products transaction system of FIG. 2 illustrating the initiation and processing of a transaction inquiry by a buyer computing device in accordance with the present invention;

FIGS. 6A and 6B are a block diagrams of the wood products transaction system of FIG. 2 illustrating the initiation and processing of a transaction inquiry by a buyer computing device in accordance with the present invention;

FIG. 7 is a block diagram of the wood products transaction system of FIG. 2 illustrating the processing of an offer by a buyer computing device in accordance with the present invention;

FIG. 8A is a block diagram of the wood products transaction system of FIG. 2 illustrating the negotiation of transaction terms between a buyer computing device and a seller computing device utilizing a transaction processing server in accordance with the present invention;

FIG. 8B is a block diagram of the wood products transaction system of FIG. 2 illustrating the initiation of a shipping transaction by a buyer computing device in accordance with the present invention;

FIG. 8C is a block diagram of the wood products transaction system of FIG. 2 illustrating the processing of shipping information in accordance with the present invention;

FIG. 9A is a block diagram of the wood products transaction system of FIG. 2 illustrating the direct negotiation of transaction terms between a buyer computing device and a seller computing device in accordance with the present invention;

FIG. 9B is a block diagram of the wood products transaction system of FIG. 2 illustrating the initiation of a shipping transaction by a seller computing device in accordance with the present invention;

FIG. 9C is a block diagram of the wood products transaction system of FIG. 2 illustrating the processing of shipping information in accordance with the present invention;

FIG. 10 is a flow diagram illustrative of a transaction processing routine implemented by a transaction processing server in accordance with the present invention;

FIG. 11 is a flow diagram illustrative of a transaction completion sub-routine implemented by a transaction processing service in accordance with the present invention;

FIG. 12 is a flow diagram illustrative of a shipping processing sub-routine implemented by a transaction processing server in accordance with the present invention;

FIG. 13 is a flow diagram illustrative of a transaction completion sub-routine implemented by a transaction processing server in accordance with the present invention;

FIG. 14 is a flow diagram illustrative of a transaction processing routine utilizing a transaction query implemented by a transaction processing server in accordance with the present invention; and

FIG. 15 is a flow diagram illustrative of a buyer inventory maintenance routine implemented by a transaction processing server in accordance with the present invention.

### DETAILED DESCRIPTION OF THE PREFERRED EMBODIMENT

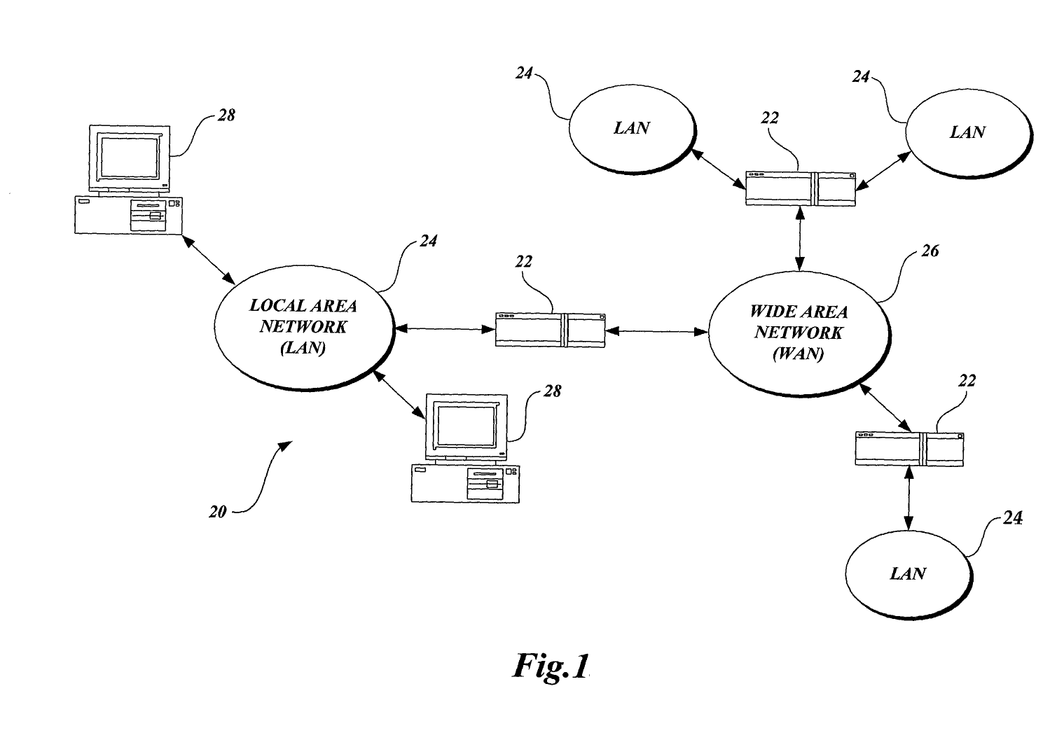

As described above, aspects of the present invention are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication between networks may utilize 56 Kbps analog telephone lines, 1 Mbps digital T-=b 1 lines, 45 Mbps T-3 lines or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at “WWW sites” or “Web sites” throughout the Internet. Other interactive hypertext environments may include proprietary environments such as those provided in America Online or other online service providers, as well as the “wireless Web” provided by various wireless networking providers, especially those in the cellular phone industry. It will be appreciated that the present invention could apply in any such interactive hypertext environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents. Imbedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the exact location of the linked document on a server connected to the Internet and describes the document. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a graphical user interface to the WWW. Upon request from the remote access user via the web browser, the web browser locates and retrieves the desired hypertext document from the appropriate web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the web server, such as JAVA applets, for execution on the client computer.

The present application is directed toward a system and method for facilitating transactions between buyers and sellers. Specifically, the present invention is directed toward a system and method for processing wood products transactions. Although the present invention will be described in regards to an implementation with an illustrative wood products transaction system, one skilled in the relevant art will appreciate that the disclosed transaction processing system and the disclosed embodiments are illustrative in nature and should not be construed as limiting.

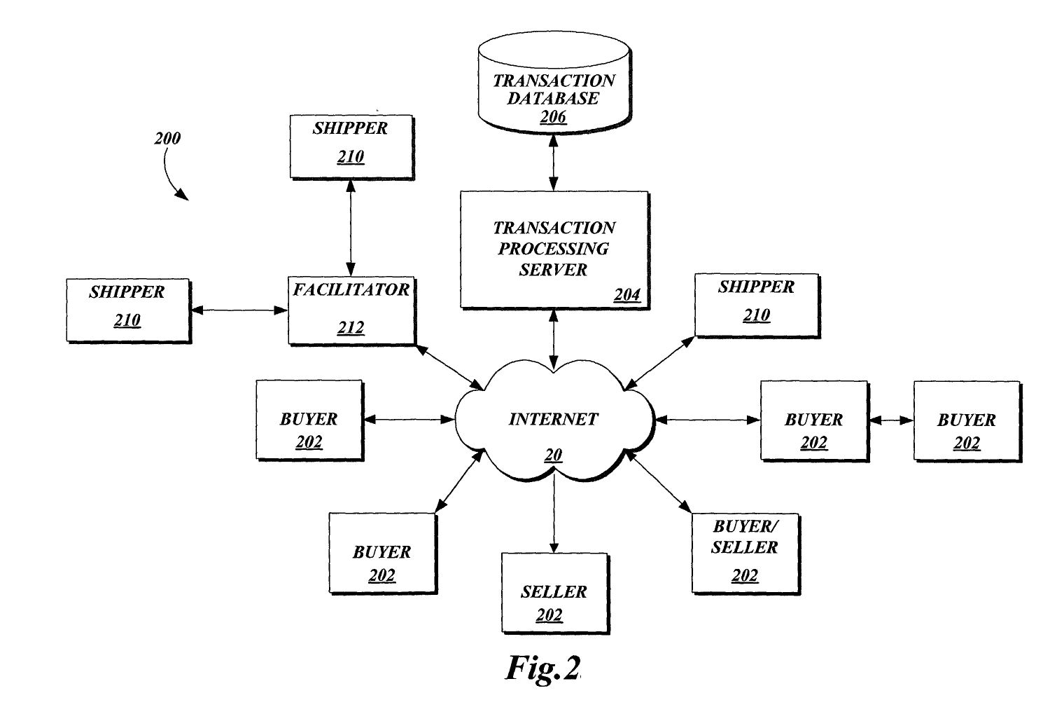

Referring now to FIG. 2, an interactive transaction processing system 200 for facilitating and processing transactions between a number of parties involved in a wood products transaction will be described. In an illustrative embodiment of the present invention, the transaction processing system 200 can be a private, subscriber-based system allowing a number of parties to interact via a common communication network, such as the Internet 20. Alternatively, the transaction processing system 200 can be a public system allowing access to any number of parties via a communication network.

As illustrated in FIG. 2, the transaction processing system 200 includes a number of buyer and seller computing devices 202. The buyer and seller computing devices 202 can include personal computers, hand-held computers, server computers, personal digital assistants, mobile computing devices, mobile telephones, and any combination thereof. Moreover, the transaction processing system 200 can include any number of buyer and/or seller computing devices 202. Additionally, the transaction processing system can include computing devices that serve as both a buyer and a seller computing device 202 and buyer computing devices 202 that will resell inventory (e.g., a distributor). However, one skilled in the relevant art will appreciate that any additional, or different, buyer and seller computing device 202 relationships may be utilized in conjunction with the present invention.

The buyer and seller computing devices 202 are in communication with at least one transaction processing server 204. The transaction processing server 204 can include a transaction database 206 for storing and processing transaction data, as will be explained in greater detail below. One skilled in the relevant art will appreciate that any one of a variety of communication media/methods may be utilized to establish a communication link with the buyer/seller computing device 202. As illustrated in FIG. 2, the buyer/seller computing devices 202 and transaction processing server 204 communicate via a global network, such as the Internet 20. Alternatively, the devices may also communicate via dedicated or semi-dedicated networks.

Also in communication with the transaction processing server 204 are one or more third-party facilitators that may be utilized by a buyer and/or seller to complete a transaction. As illustrated in FIG. 2, the transaction processing system 200 can include one or more shippers 210 for providing shipping services related to a transaction. Additionally, the transaction processing system 200 can include shipping facilitators 212 that can represent one or more shippers 210. One skilled in the relevant art will appreciate that any number of additional or different third-party providers may also be included in the transaction processing system 200, including, but not limited to, insurance agents, warehouse providers, manufacturers, agents, and the like. All are considered to be within the scope of the present invention.

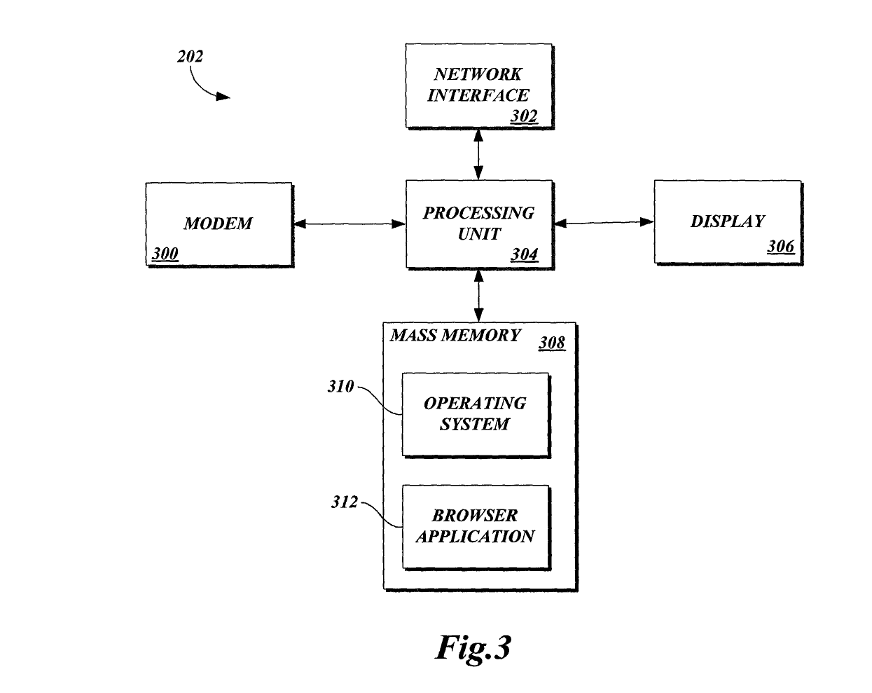

FIG. 3 depicts several of the key components of the buyer and/or seller computing device 202 (FIG. 2). Those of ordinary skill in the art will appreciate that the buyer/seller computing device 202 includes many more components than those shown in FIG. 3. However, it is not necessary that all of these generally conventional components be shown in order to disclose an illustrative embodiment for practicing the present invention.

As shown in FIG. 3, the buyer/seller computing device 202 may include a modem 300 for connecting to an Internet service provider through a Point-to-Point Protocol (“PPP”) connection or a Serial Line Internet Protocol (“SLIP”) connection as known to those skilled in the art. The modem 300 may utilize a telephone link, cable link, wireless link, Digital Subscriber Line or other types of communication links known in the art. The buyer/seller computing device 202 may also include a network interface 302 for connecting directly to a LAN or a WAN, or for connecting remotely to a LAN or WAN. Those of ordinary skill in the art will appreciate that the network interface 302 includes the necessary circuitry for such a connection, and is also constructed for use with various communication protocols, such as the TCP/IP protocol, the Internet Inter-ORB Protocol (“IIOP”), and the like. The network interface 302 may utilize the communication protocol of the particular network configuration of the LAN or WAN it is connecting to, and a particular type of coupling medium.

The buyer/seller computing device 202 also includes a processing unit 304, a display 306, and a memory 308. The memory 308 generally comprises a random access memory (“RAM”), a read-only memory (“ROM”), and a permanent mass storage device, such as a hard disk drive, tape driver, optical drive, floppy disk drive, CD-ROM, DVD-ROM, or removable storage drive. The memory 308 stores an operating system 310 for controlling the operation of the buyer/seller computing device 202. The memory 308 also includes a WWW browser 312, such as Netscape's NAVIGATOR® or Microsoft's INTERNET EXPLORER® browsers, for accessing the transaction processing system via the WWW. It will be appreciated that these components may be stored on a computer-readable medium and loaded into memory 308 of the buyer/seller computing device 202 using a drive mechanism associated with the computer-readable medium, such as a floppy, CD-ROM, DVD-ROM drive, or network interface 302. The memory 308, display 306, modem 300 and network interface 302 are all connected to the processor 304 via a bus. Other peripherals may also be connected to the processor in a similar manner.

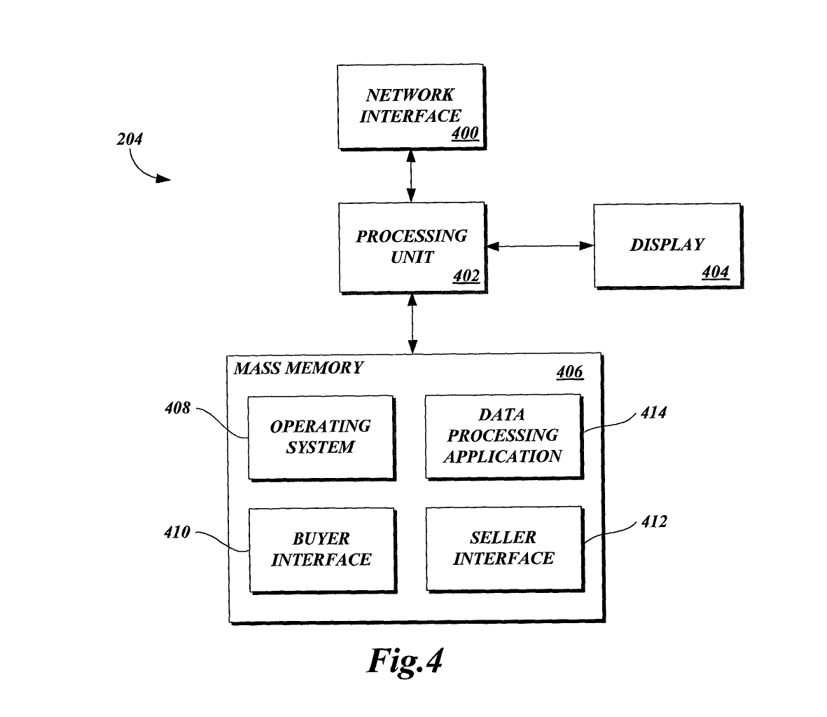

FIG. 4 is a block diagram depicting an illustrative architecture of a transaction processing server 204 (FIG. 2) in accordance with the present invention. Those of ordinary skill in the art will appreciate that the transaction processing server 204 includes many more components than those shown in FIG. 4. However, it is not necessary that all of these generally conventional components be shown in order to disclose an illustrative embodiment for practicing the present invention. As shown in FIG. 4, the transaction processing server 204 is connected to the Internet 20 via a network interface 400. Those of ordinary skill in the art will appreciate that the network interface 400 includes the necessary circuitry for connecting the transaction processing server 204 to the Internet 20, and is constructed for use with the TCP/IP protocol, or other protocols, such as IIOP.

The transaction processing server 204 also includes a processing unit 402, a display 404 and a mass memory 406, all connected via a communication bus, or other communication device. The mass memory 406 generally comprises a RAM, ROM, and a permanent mass storage device, such as a hard disk drive, tape drive, optical drive, floppy disk drive, or combination thereof. The mass memory 406 stores an operating system 408 for controlling the operation of the transaction processing server 204. It will be appreciated that this component may comprise a general-purpose server operating system as is known to those skilled in the art, such as UNIX, LINUX™, or Microsoft WINDOWS NT®.

The mass memory 406 also stores program code and data for interfacing with one or more buyers, one or more sellers, additional third-parties, and for processing wood products transaction data. More specifically, the mass memory 406 stores a buyer interface application 410 in accordance with the present invention for presenting a buyer with various transaction information, obtaining buyer transaction inquiries and notifying buyers of completed transactions. The buyer interface application 410 comprises computer-executable instructions which, when executed by the transaction processing server 204, transmits and receives buyer data as will be explained below in greater detail. The mass memory 406 also stores a seller interface application program 412 for obtaining seller inventory information and for transmitting completed transaction information to the seller. The operation of the seller interface application 412 will be described in greater detail below. Although the mass memory 406 is illustrated as including separate interface applications 410, 412 for buyers and sellers, one skilled in the relevant art will appreciate that the mass memory may utilize a single interface application for communicating with buyer computing devices 202, seller computing devices 202, and any additional party in the transaction processing system 200.

The mass memory 406 further stores a data processing 414 for associating buyer and seller data in accordance with the transaction processing aspect of the present invention. The operation of the data processing application 414 will be described in greater detail below. It will be appreciated that these components may be stored on a computer-readable medium and loaded into the memory 406 of the transaction processing server 204 using a drive mechanism associated with the computer-readable medium, such as a floppy, CD-ROM, DVD-ROM drive, or network interface 400.

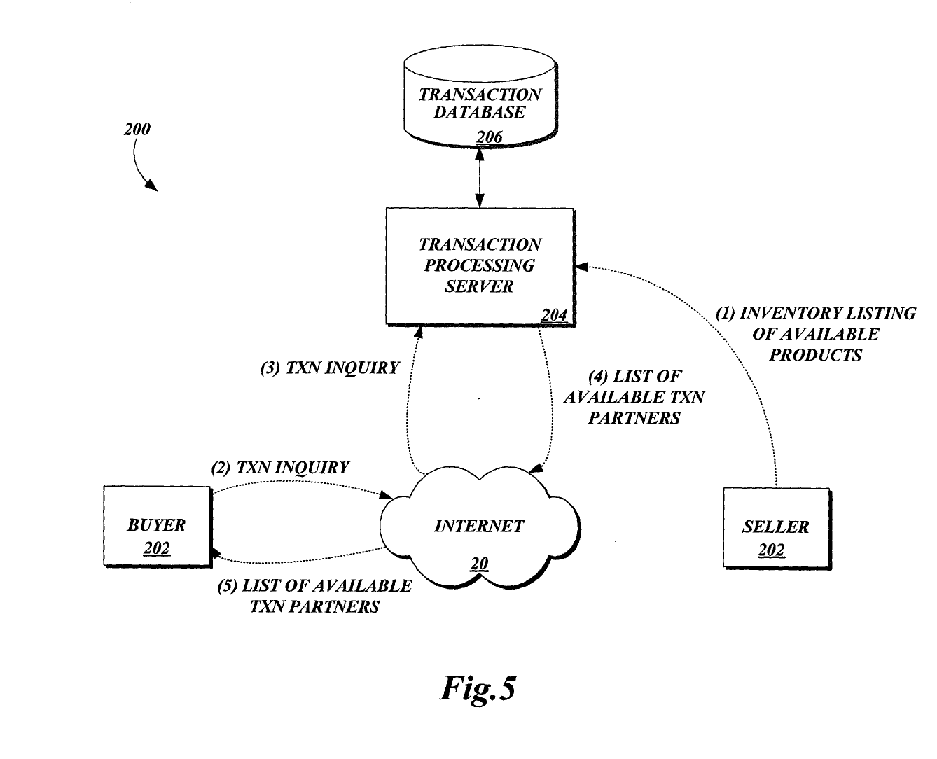

Referring now to FIGS. 5-9C, a number of embodiments implementing various aspects of the present invention will be described. FIG. 5 is a block diagram of the wood products transaction system of FIG. 2 illustrating the initiation of a transaction inquiry by a buyer computing device 202 and the processing of a transaction inquiry by the transaction processing server 204 in accordance with the present invention. One or more seller computing devices 202 providing the transaction processing server 204 with data relaying the types and quantities of inventory available for a transaction. As illustrated in FIG. 5, the seller computing devices 202 may communicate directly with the transaction processing server 204, or alternatively, may transmit the inventory data through the communication network 20.

A buyer computing device 202 can access the transaction processing system 200 by logging into a transaction processing service, such as a Web site, generating a transaction inquiry. The transaction inquiry is then transmitted to the transaction processing server 204. In an actual embodiment of the present invention, the initiation of the transaction inquiry may include multiple sessions with the transaction processing server 204. For example, a potential buyer may browse a Web site provided by the transaction processing server 204 to familiarize himself or herself with the products that may be available, the sellers that are currently offering product specials, and the like. Accordingly, the transaction inquiry sent by the buyer computing device involves an initial request to begin a transaction, or set of transactions, by the buyer. One skilled in the relevant art will appreciate that although FIG. 5 illustrates the seller computing device 202 transmitting available inventory prior to a buyer initiating a transaction inquiry, the order of the buyer and seller computing device transmission may be altered or may be relatively concurrent.

Upon receiving the transaction inquiry, the transaction processing server 204 generates a list of available transaction partners and their product specifications and transmits the list to the buyer computing device 202. In an illustrative embodiment of the present invention, the list of available transaction partners, may be generated in the form of a Web page for viewing on the buyer computing device 202 browser application 312. Alternatively, the list may be generated and transmitted to the buyer computing device 202 by other communications mediums such as electronic mail messages, short message service, voice communications, documentation, and the like.

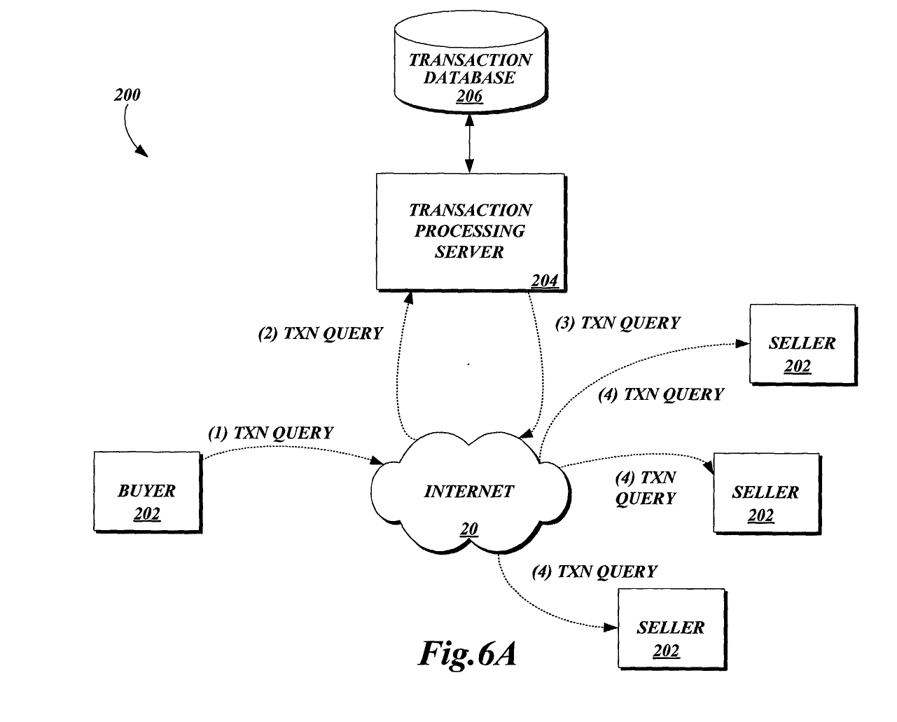

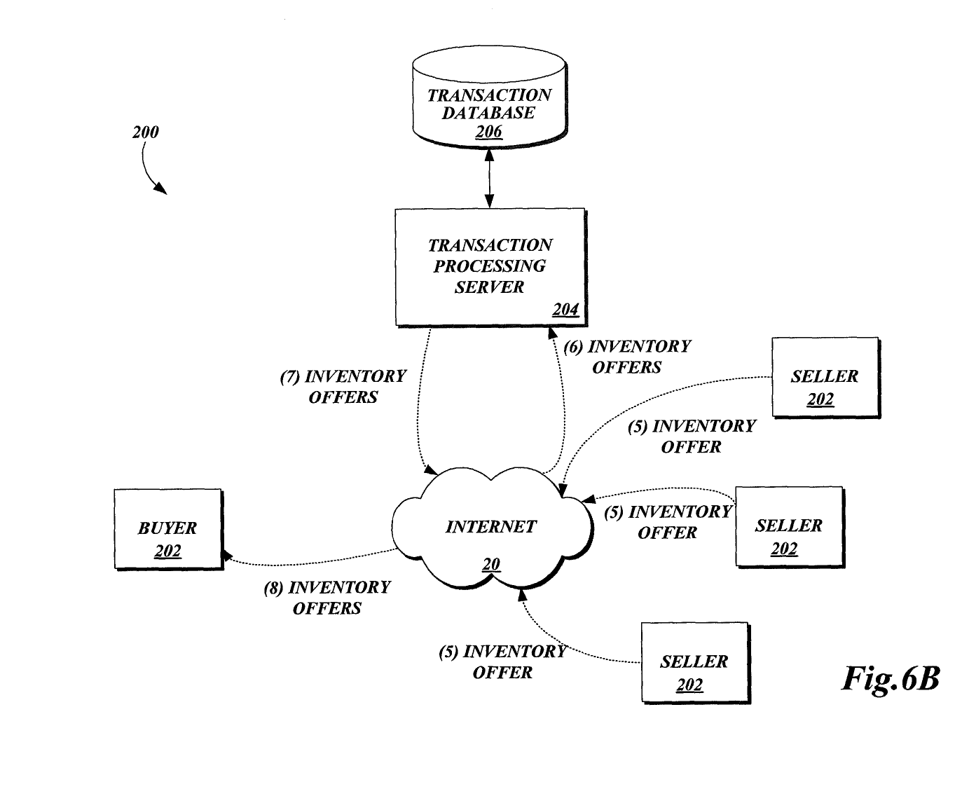

With reference now to FIGS. 6A and 6B, an alternative embodiment for initiating a buyer computing device 202 transaction will be described. With reference to FIG. 6A, a buyer computing device 202 initiates a transaction query that is transmitted to the transaction processing server 204. In an illustrative embodiment of the present invention, the transaction query includes one or more criteria in which the buyer is requesting bids/requests for quotes from one or more seller computing devices 202. Accordingly, the transaction processing server 204 transmits the transaction queries to one or more seller computing devices 202 that qualify to submit bids to buyer computing device 202. As will be explained in greater detail below, in an illustrative embodiment, the buyer computing device 202 may designate criteria that facilitates the selection of which seller computing devices 202 receive the transaction query.

With reference now to FIG. 6B, in response to the transaction query, one or more seller computing devices 202 can generate inventory quotes, or invitations to offer, informing the buyer computing device 202 of the seller's available inventory and terms. The inventory offers are transferred to the transaction processing server 204 and subsequently transmitted to the buyer computing device 202. One skilled in the relevant art will appreciate that the inventory offers may be transmitted in a variety of formats including as Web pages, Web forms, electronic mail, voice communication and the like.

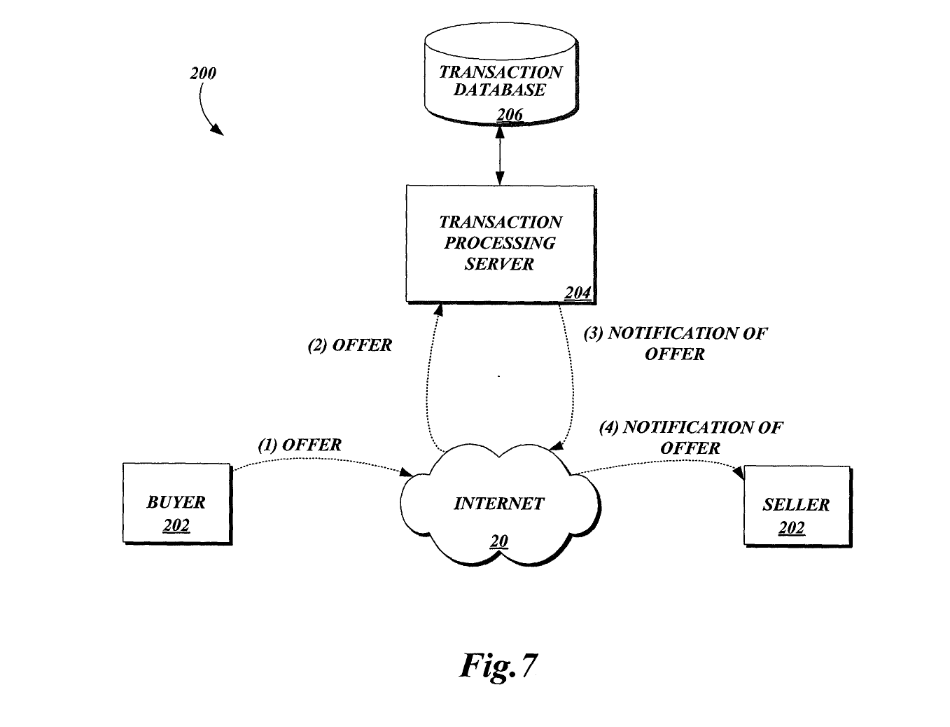

Turning to FIG. 7, once the buyer computing device 202 has received the seller information, the buyer computing device 202 can generate an offer to one or more seller computing devices to initiate transaction negotiations. The buyer offer is transmitted to the transaction processing server 204, which in turn forwards the notification to each corresponding seller computing device 202. In an illustrative embodiment of the present invention, the initiation of a buyer offer may be accomplished by manipulation of a Web page provided by the transaction processing server 204 via the Internet. Alternatively, the buyer computing device 202 may generate a communication, such as in the form of an electronic mail, short message service message, voice communication, and the like, and transmit the message to the seller computing device 202, via the transaction processing server.

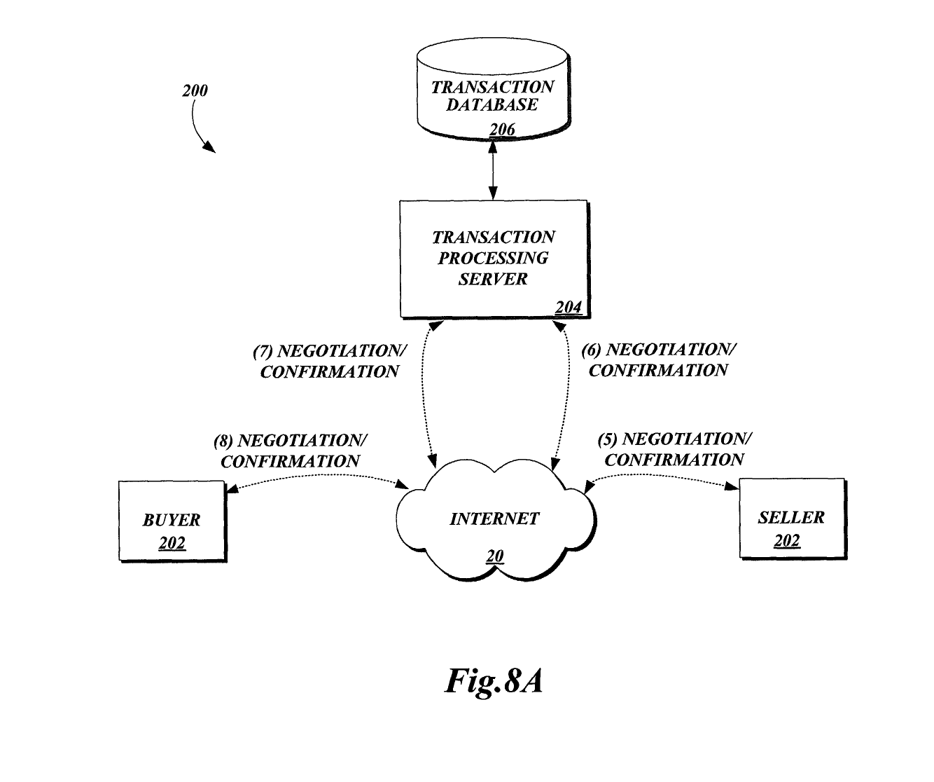

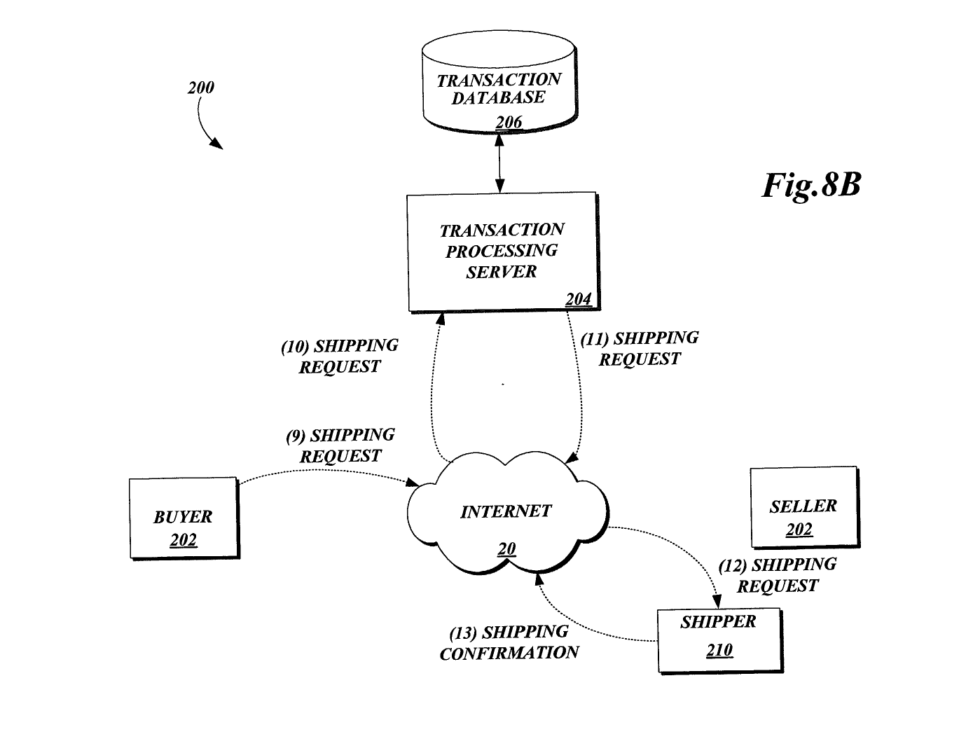

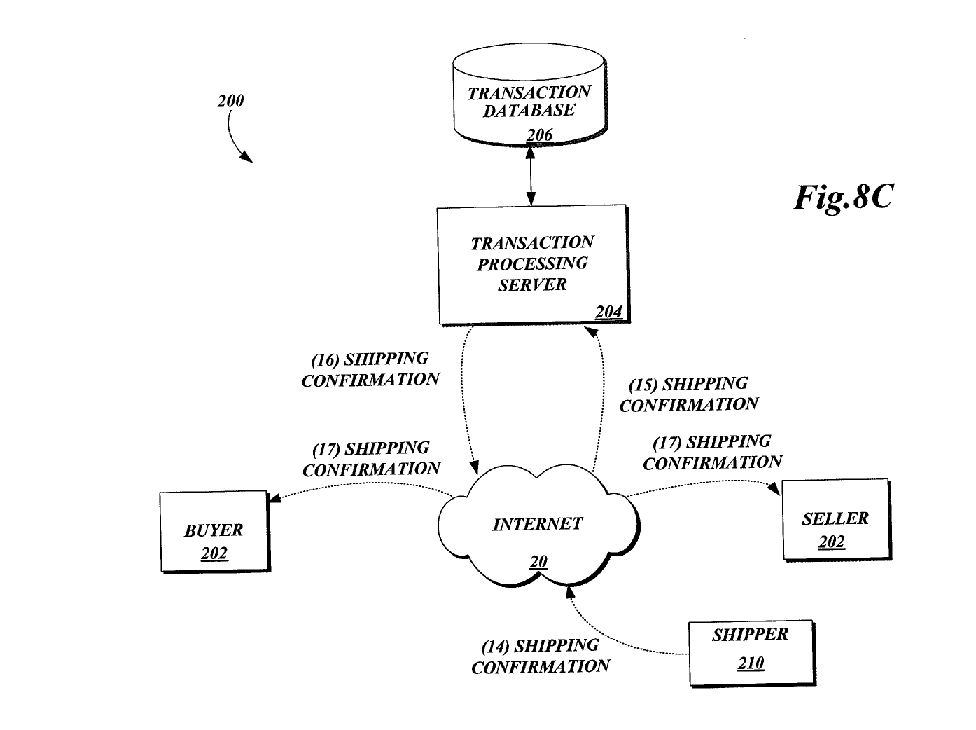

FIGS. 8A-8C are block diagrams of the transaction processing system 200 of FIG. 2 illustrating the completion with aspects of a wood products transaction in accordance with the present invention. More specifically, FIGS. 8A-8C illustrate an embodiment in which communications between the buyer computing device 202, the seller computing device 202, and a shipper 210 are facilitated through the transaction processing server 204. With reference to FIG. 8A, after the seller computing device 202 receives a notification of an offer (FIG. 7), the seller computing device 202 initiates a negotiation/confirmation communication to the buyer computing device 202 via the transaction processing server 204. In an illustrative embodiment of the present invention, and as illustrated in FIG. 8A, the negotiations between the parties may entail any number of communications (e.g., offers and counteroffers) between the buyer and the seller. However, once an agreement has been reached, a confirmation is sent by either the buyer computing device 202, the seller computing device 202, or both parties to the transaction processing server 204.

With reference now to FIG. 8B, an embodiment for initiating a shipping request in accordance with the present invention will be described. In this illustrative embodiment, it will be assumed that the buyer has assumed responsibility for completing a shipping transaction. Similar to the initiation of a transaction inquiry, the transaction processing server 204 may provide a list of shippers that are available for service and the terms of service. Accordingly, the buyer computing device initiates a shipping request that is transferred to the selected shipper(s) via the transaction processing server. In an actual embodiment of the present invention, the initiation of the shipping request can be processed as a part of a single transaction.

With reference to FIG. 8C, upon receiving the shipping request, the shipper generates a shipping confirmation that can be transferred to the buyer computing device 202, the seller computing device 202, and any additional party via the transaction processing server 204. In an illustrative embodiment of the present invention, the confirmation to each party may be a uniform communication, such as to a Web site provided by the transaction processing server 204. Alternatively, the transaction processing server 204, or the shipper 210, may direct individualized notifications to each party, such as electronic mail, short message service, and the like.

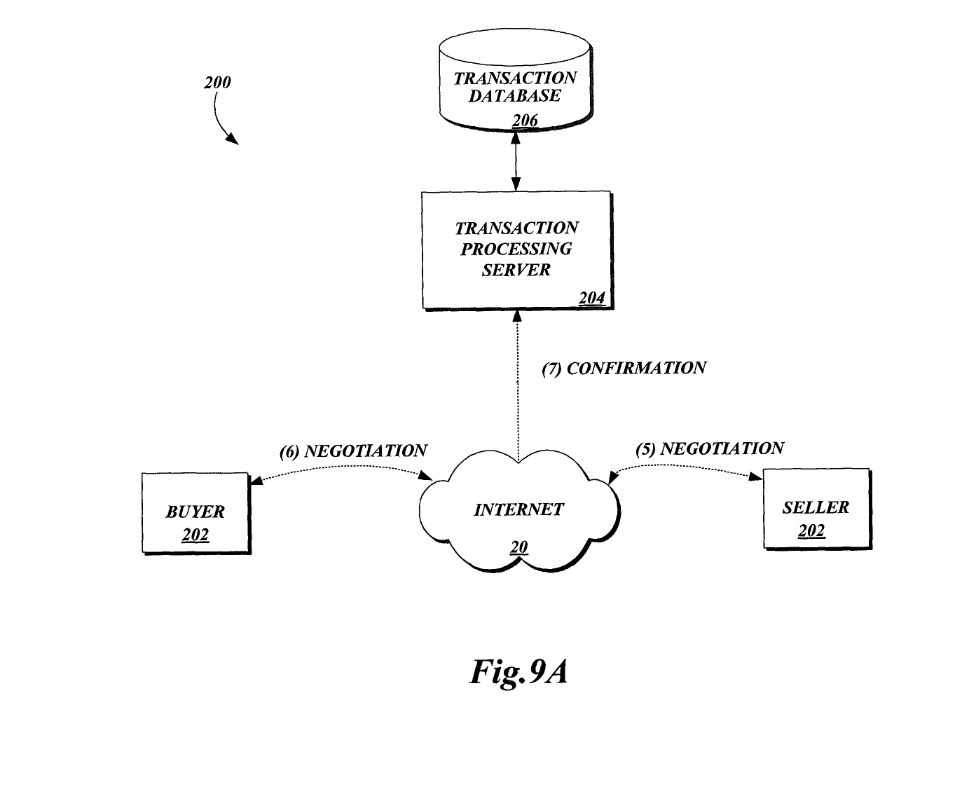

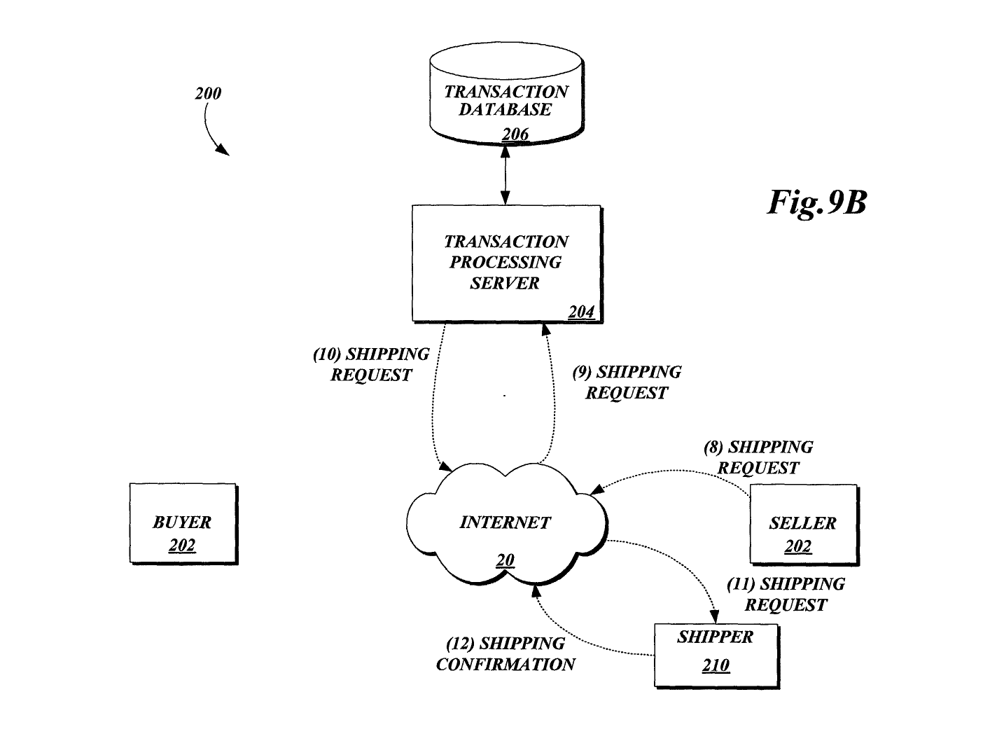

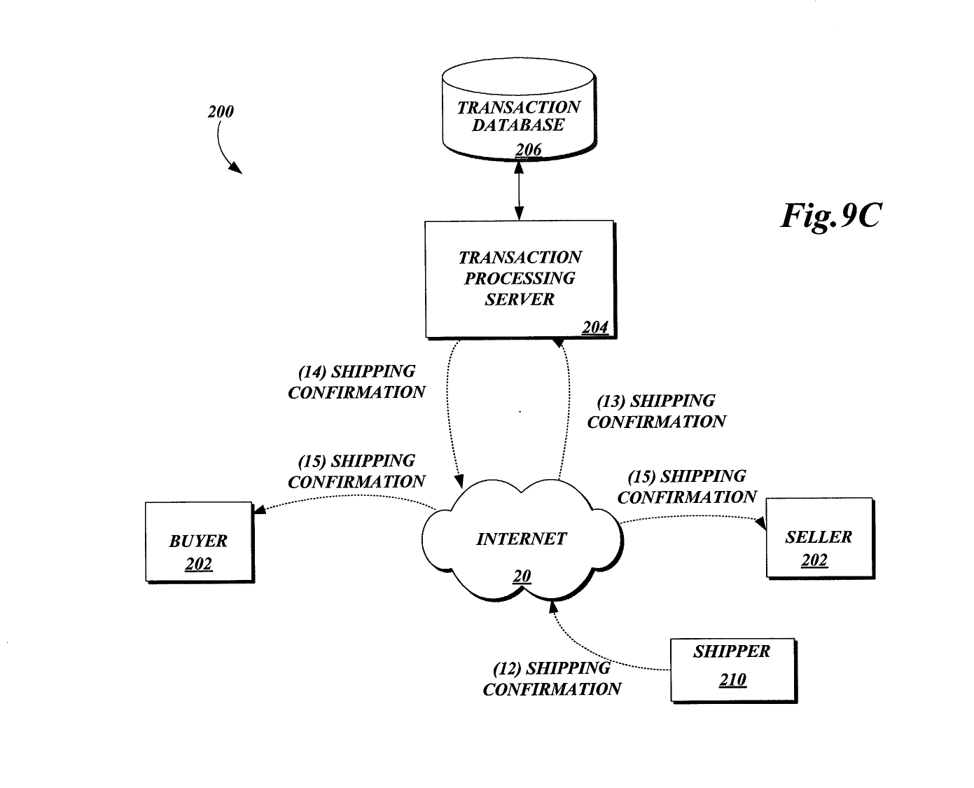

FIGS. 9A-9C are block diagrams of the transaction processing system 200 of FIG. 2 illustrating the completion with aspects of a wood products transaction in accordance with the present invention. More specifically, FIGS. 9A-9C illustrate other embodiments in which communications between the buyer computing device 202, the seller computing device 202, and a shipper 210 are facilitated through the transaction processing server 204. With reference to FIG. 9A, after the seller computing device 202 receives a notification of an offer (FIG. 7), the seller computing device 202 initiates a negotiation/confirmation communication to the buyer computing device 202. In the illustrative embodiment of the present invention illustrated in FIG. 9A, however, the negotiations between the parties may involve one or more direct communications between the parties that are not communicated via the transaction processing server 204. For example, the transaction processing server 204 may establish a telephone communication channel, either utilizing standard telephone communication mediums and/or the Internet 20, such that the buyer and seller may communicate directly. Additionally, similar to FIG. 8A, the direct communications may entail any number of communications (e.g., offers and counteroffers) between the buyer and the seller. However, once an agreement has been reached, a confirmation is sent by either the buyer computing device 202, the seller computing device 202, or both parties to the transaction processing server 204. One skilled in the relevant art will appreciate that the ability for the transaction processing system 200 to facilitate direct communications between the parties as part of a transaction facilitated through the system 200 can preserve aspects of the traditional transaction practices, such as those found in the wood products field.

With reference now to FIG. 9B, another embodiment for initiating a shipping request in accordance with the present invention will be described. In this illustrative embodiment, it will be assumed that the seller has assumed responsibility for completing a shipping transaction. Similar to the initiation of a transaction inquiry, the transaction processing server 204 may provide a list of shippers that have are available for service, or otherwise selected by either party. Accordingly, the buyer computing device initiates a shipping request that is transferred to the selected shipper(s) via the transaction processing server. In an actual embodiment of the present invention, the initiation of the shipping request can be processed as a part of a single transaction. Although the shipping request is processed by the transaction processing server 204, one skilled in the relevant art will appreciate that the transaction processing server 204 may also facilitate direct communications with the additional parties similar to the process illustrated in FIG. 9A.

With reference to FIG. 9C, upon receiving the shipping request, the shipper generates a shipping confirmation that can be transferred to the buyer computing device 202, the seller computing device 202, and any additional party via the transaction processing server 204. In an illustrative embodiment of the present invention, the confirmation to each party may be a uniform communication, such as to a Web site provided by the transaction processing server 204. Alternatively, the transaction processing server 204, or the shipper 210, may direct individualized notifications to each party, such as electronic mail, short message service, and the like.

Although FIGS. 8A-8C and 9A-9C illustrate the additional involvement of a shipper, one skilled in the relevant art will appreciate that any number of different and/or additional parties may be included as part of the transaction facilitated by the transaction processing server 204. For example, a similar process as illustrated in FIGS. 8A-8C or 9A-9C may be implemented to involve insurance agents, warehouse providers, distributors, custom agents, and the like. Accordingly, the transaction processing system and method of the present invention may also be modified to incorporate the specific communication/transaction requirements of each individual party included in the transaction.

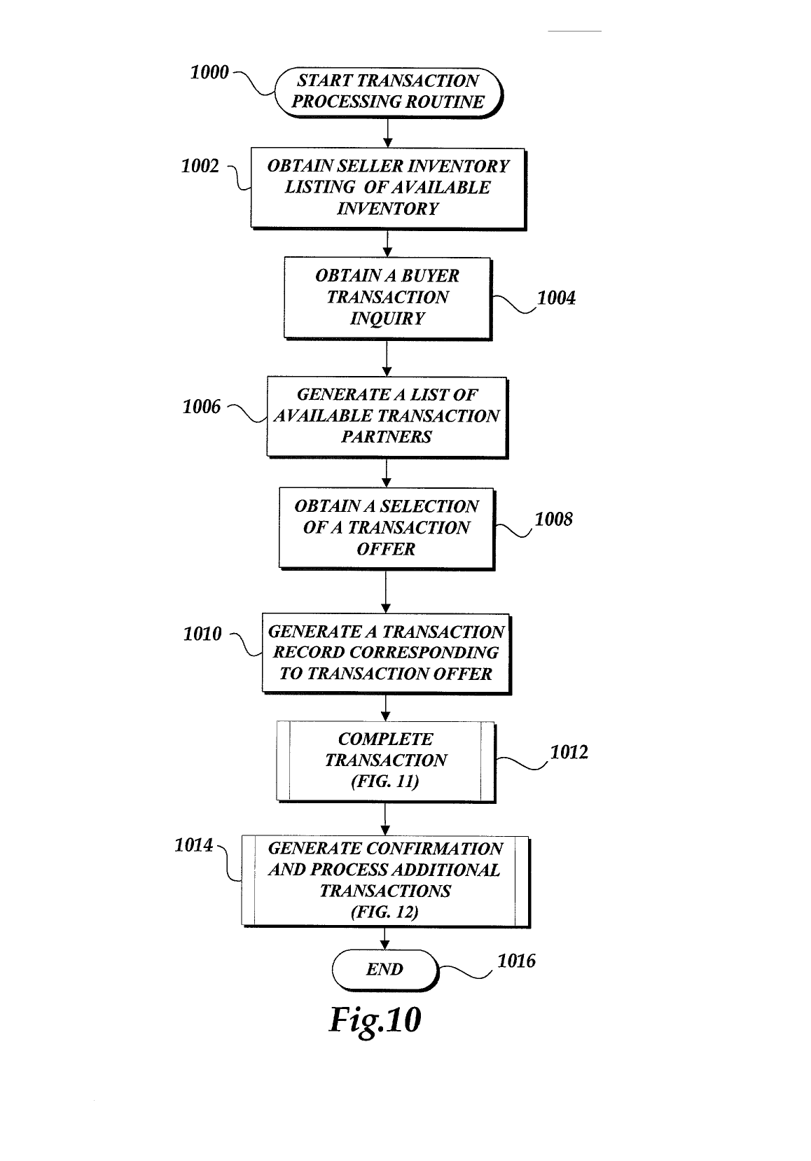

With reference to FIG. 10, a routine 1000 implemented by the transaction processing server 204 for processing wood products transaction between buyers and sellers in accordance with the present invention will be described. At block 1002, the seller interface application 412 of the transaction processing server 204 obtains seller inventory listings of available seller inventory from one or more seller computing devices 202. In an illustrative embodiment of the present invention, the seller interface application 412 may obtain the seller inventory data in a variety of manners, including via a Web page interface, electronic mail, facsimile, electronic files (XML file, EDI, etc.), and the like. Moreover, as will be explained in greater detail below, the seller inventory data may specify product quantities, product identifications, and the like in a proprietary, or individualized, form utilized by the seller.

At block 1004, the buyer interface application 410 of the transaction processing server 204 obtains a buyer transaction inquiry from the buyer computing device 202. As explained above with regard to FIG. 5, the buyer transaction inquiry may be initiated by a Web page interface, an electronic mail, facsimile, electronic files (XML file, EDI, etc.), and the like. Moreover, in an illustrative embodiment of the present invention, the buyer, via the buyer computing device 202, may browse information provided by the transaction processing server 204, such through a Web page, prior to making a transaction inquiry. For example, a buyer, via the buyer computing device 202, may initiate sample queries to identify available quantities, prices, and/or sellers. The buyer may also receive advertisements inviting them to examine a particular seller. Additionally, similar to the seller inventory data, the buyer transaction request may specify the transaction inquiry in terms of quantities, product identifications and the like in a proprietary, or individualized, format.

At block 1006, the data processing application 414 generates a list of available transaction partners and their respective terms for the buyer computing device 202. In an illustrative embodiment of the present invention, the data processing application 414 may utilize a variety of criteria to generate the list of available transaction partners. However, one skilled in the relevant art will appreciate that additional or alternative criteria may be considered by the data processing application 414 to generate the list of available transaction partners.

In one aspect, the data processing application 414 can maintain correlation information in the transaction database 206 to correlate quantity and/or product identifier information sent by the seller computing device 202 with quantity and/or product identifier information sent by the buyer computing device 202. For example, a particular seller may utilize non-industry standard product nomenclature to refer to some, if not all, of its products. Nevertheless, the correlation application 414 can still match buyer requests, utilizing the industry standards, to the seller's inventory data.

In another aspect, the data processing application 414 may utilize buyer and/or seller specified data to include/exclude certain individual businesses, or types of businesses, from the list of available transaction partners. More specifically, in an illustrative embodiment of the present invention, the data processing application 414 can utilize a three-tiered approach to include/exclude businesses. Under a three-tiered approach, a party can include or exclude parties according to a general classification. For example, a buyer may indicate that her or she to buy from certified wholesalers. Accordingly, the data processing application 414 would include any seller that could be classified as a certified wholesaler. Similarly, the buyer may indicate that he or she wishes to buy from sellers from a particular geographic region. Accordingly, the data processing application 414 would include sellers classified as being located in the selected geographic region. In another application, a party can include or exclude particular individual parties by identifying them directly. For example, a buyer may indicate that he or she wishes to buy from ABC Corporation. Accordingly, the data processing application 414 would include any seller that is associated with ABC Corporation. Additionally, in accordance with an illustrative three-tiered approach, a party may also include or exclude parties by utilizing a combination of criteria. For example, a buyer may wish to include all wholesalers, but specifically wish to exclude XYZ Corporation, even though they qualify as a wholesaler and would otherwise be included in the list of available inventory. In addition to the illustrative examples of the three-tiered approach from the buyer perspective, one or more seller's may also submit data specifying whether they wish to be included or excluded from a specific buyer request. For example, a specific seller may only wish to sell wood products to distributors and not to any retail sellers. Additionally, a seller may wish to exclude themselves from transactions in which a competitor may be given the seller's pricing, quantity or product information.

At block 1008, the buyer interface application 410 obtains a selection of a transaction offer from the buyer computing device 202. In an illustrative embodiment of the present invention, the transaction offer from the buyer computing device 202 may be facilitated through the utilization of a Web page format that allows a buyer, through a browser application 312, to fill in forms. Alternatively, the offer may be transmitted via electronic mail, short message service, facsimile and the like. Additionally, in another aspect of the present invention, the transaction processing server 204 may maintain some pre-entered user data such that the buyer is not required to enter in at least some of the terms. Further, the data processing application 414 may also maintain a history of the purchasing selections that the buyer has transmitted in this session, or in previous sessions, such that the purchasing selection data is pre-entered in subsequent forms. For example, assume that the buyer has previously entered the shipping address, contact information, etc. by manipulating graphical icons on a Web-based buyer request form. In accordance with the present invention, the data processing application 414 may store and reuse at least some of the data for each subsequent transaction form that is required from the buyer.

At block 1010, the data processing application generates one or more transaction records corresponding to offers obtained from the buyer computing device 202. As explained above, the data processing application may import any additional data related to the buyer and/or process the buyer inputted data into a format specified by the particular selling computing device. At block 1012, the transaction processing server completes the transaction.

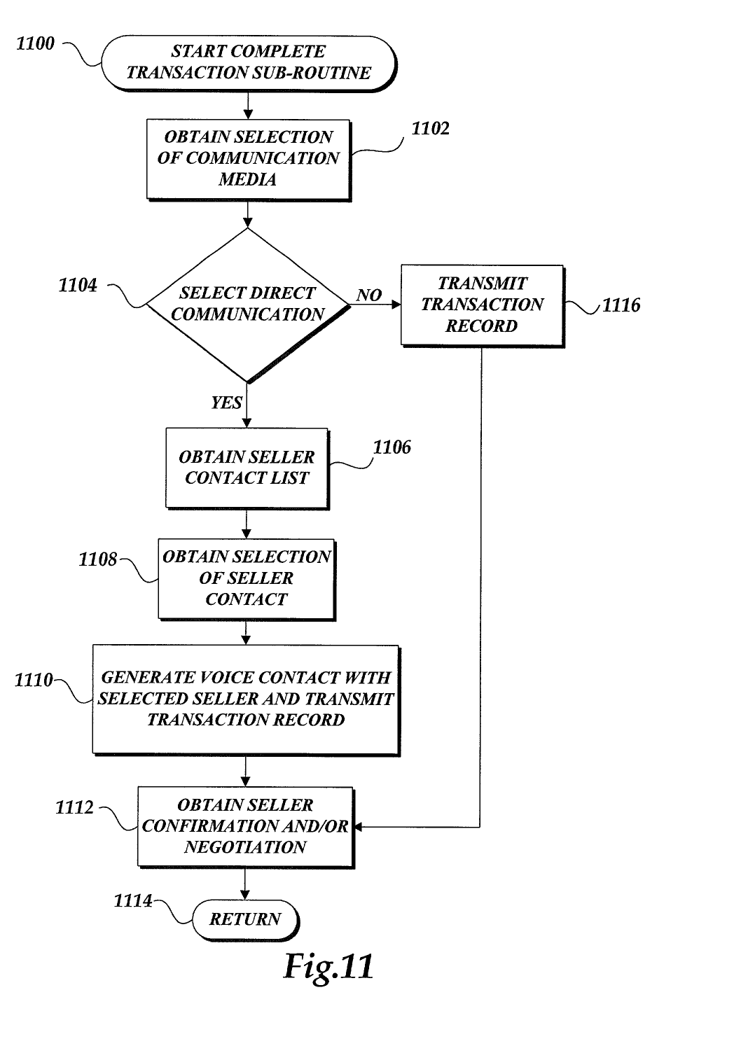

As explained above, in accordance with the present invention, the buyer computing device 202 and selling device 202 may negotiate and/or complete a proposed transaction by communicating via the transaction processing server 204 or by directly communicating with each other. Accordingly, FIG. 11 is a flow diagram illustrative of a transaction completion sub-routine 1100 implemented by the transaction processing server 204 in which the buyer computing device 202 is given the option of a direct communication with seller computing device 202. However, one skilled in the relevant art will appreciate that the buyer computing device 202 choice may be omitted altogether, or modified.

At block 1102, the buyer interface application 410 obtains a selection of a preferred communication method. At decision block 1104, a test is conducted to determine whether a direct communication medium has been selected. If a direction communication has been selected, at block 1106, the buyer interface application 410 generates and transmits a list of seller contacts. In an illustrative embodiment of the present invention, the data processing application 414 may maintain a database of seller or buyer specified data relating to contact preferences for a direct communication. At block 1108, the buyer interface application 410 obtains a selection of a seller contact.

At block 1110, the seller interface application 412 generates a direct contact with the seller and transmits a transaction record. In an illustrative embodiment of the present invention, the direct contact may in the form of a voice communication channel generated between the buyer and the seller. For example, if the buyer computing device 202 and the seller computing device 202 include network voice capability, the transaction processing server 204 may utilize the Internet 20 to provide voice communication between the parties. Alternatively, the transaction processing server 204 may include telephonic interface components that would be operable to allow voice communication via one or more standard telephonic communication channels. Still further, the transaction processing server 204 may utilize additional, supplemental or alternative direct communications, including, but not limited to, short messaging service, instant messaging, video communications, and the like.

In addition to establishing the direct communication channel, the seller interface application 412 also transmits a transaction record to the selected seller contact information. The transaction record can include data corresponding to the selected transaction, including the data submitted by the buyer and/or the data processing application 414. In an illustrative embodiment of the present invention, the transaction record may be made available to the seller computing device 202 via a Web page interface. Alternatively, the transaction record may be transmitted via electronic mail, short message service, and the like. Further, the seller interface application 412 may also transmit a notification, such as electronic mail, telephone message, textual page, and the like, to notify a seller of a pending transaction offer.

Referring to decision block 1104, if a direct communication method is not selected, the seller interface application 412 transmits a transaction record to the seller computing device 202, as described. At block 1112, the transaction processing server 204 obtains confirmation that the transaction has been completed. In an illustrative embodiment of the present invention, the transaction processing server 204 may also obtain and store negotiation information as the party offers/counteroffers are submitted. Alternatively, the transaction processing server 204 may only obtain a notification if a transaction can be completed. At block 1114, the sub-routine returns to routine 1000.

Returning to FIG. 10, at block 1014, the transaction processing server 204 generates all confirmation records and processes any additional transactions with one or more third parties. In an illustrative embodiment of the present invention, the confirmation records can include notifications to all the parties that the transaction completion has been received. Additionally, the notification can include prompts, by the transaction processing server 204 that additional parties need to be contacted or involved. The notifications may be facilitated through a Web page interface, or via electronic mail, textual pages, voice communications, short message service, and the like. Further, the notifications can be utilized by both the buyer computing device 202 and the seller computing device 202 to integrate with several back office systems, such as an accounting system, to mitigate the need to re-enter any of the transaction data. In an actual embodiment of the present invention, the computing devices 202 may maintain some type of software agent that facilitates communication with the transaction processing server 204. At block 1016, the routine 1000 terminates.

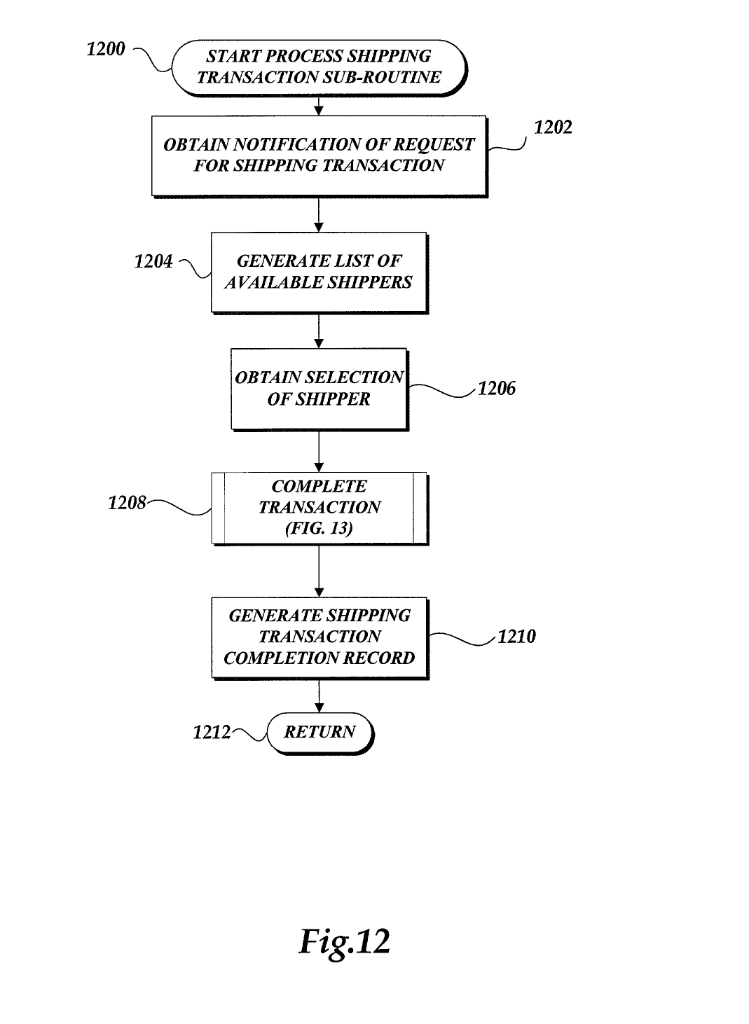

As explained above, a wood products transaction, as well as any other transaction, may also involve any number of additional third parties. Accordingly, at block 1112, the transaction processing server 204 may facilitate the identification of one or more third party service providers and the initiation of additional transactions with the identified third parties. FIG. 12 is a flow diagram illustrative of a process shipping transaction sub-routine 1200 implemented by the transaction processing server 204 in accordance with the present invention. One skilled in the relevant art will appreciate that the transaction processing server 204 may initiate any number of additional routines to process each additional third party separately or as part of a single transaction.

With reference to FIG. 12, at block 1202, the transaction processing server 204 obtains a notification of a request for a shipping transaction. In an illustrative embodiment of the present invention, the request for a shipping transaction may be submitted by either the buyer computing device 202 or the seller computing device 202, or both. Additionally, the request may be submitted via a Web page interface, or other communication methods. At block 1204, the data processing application 1204 generates a list of available shippers and their respective terms. Similar to the list of available transaction partners in block 1004 (FIG. 10), the data processing application 414 may utilize both data correlation information and party specified preferences to generate the list of available shippers.

At block 1206, the transaction processing server 204 obtains a selection of one or more shippers to provide a shipping quote. At block 1208, the transaction processing server 1208 completes the transaction. In an illustrative embodiment of the present invention, the transaction processing server 204 may complete the transaction with a shipper in a manner similar to the completion of a transaction with a buyer/seller (FIG. 11). Additionally, the data processing application 414 may also maintain and utilize the data collected during the completion of the transaction between the buyer and sell to minimize the entry of redundant data. At block 1210, the transaction processing server 204 generates shipping and transaction completion records and the sub-routine 1200 returns as block 1212.

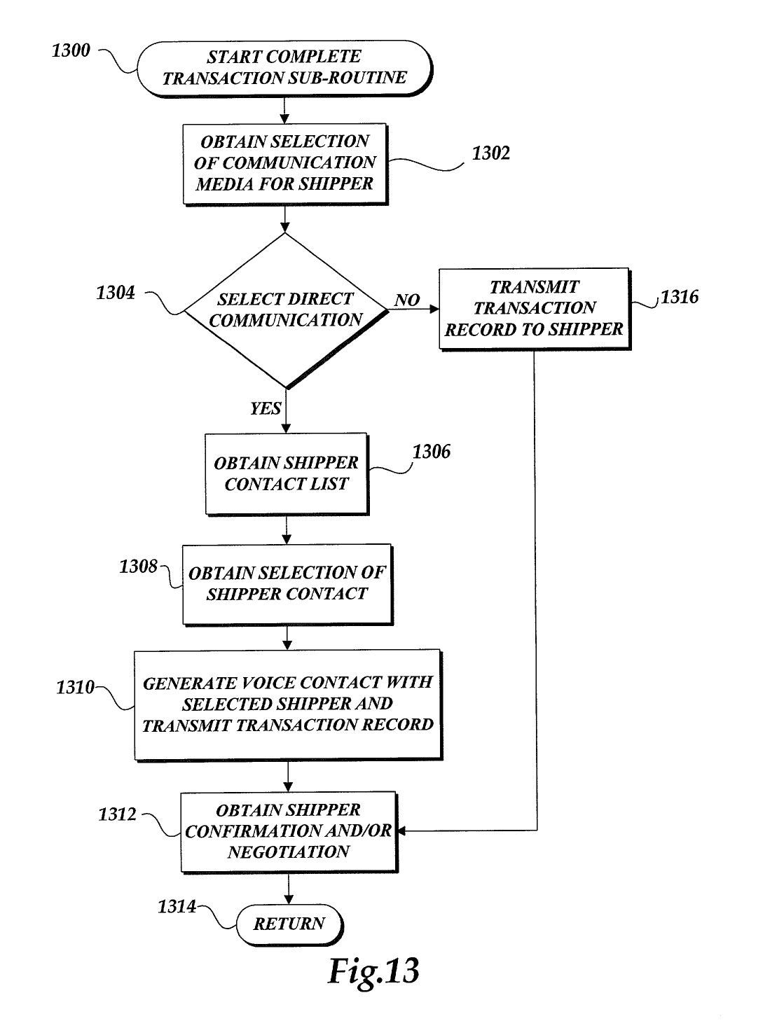

FIG. 13 is a block diagram illustrative of a shipper transaction completion sub-routine 1300 implemented by a transaction processing server 204 in accordance with the present invention. At block 1302, the transaction processing server 204 obtains a selection of a preferred communication method. At decision block 1304, a test is conducted to determine whether a direct communication medium has been selected. If a direction communication has been selected, at block 1306, the transaction processing server 204 generates and transmits a list of shipper contacts. In an illustrative embodiment of the present invention, the data processing application 414 may maintain a database of seller, buyer, and/or shipper specified data relating to contact preferences for a direct communication. At block 1308, the transaction processing server 204 obtains a selection of a shipper contact.

At block 1310, the transaction processing server generates a direct contact with the specified shipper and transmits a transaction record. In an illustrative embodiment of the present invention, the direct contact may in the form of a voice communication channel generated between the buyer/seller and the selected shipper. For example, if the buyer computing device 202 and the shipper 210 include network voice capability, the transaction processing server 204 may utilize the Internet 20 to provide voice communication between the parties. Alternatively, the transaction processing server 204 may include telephonic interface components that would be operable to allow voice communication via one or more standard telephonic communication channels. Still further, the transaction processing server 204 may utilize additional, supplemental or alternative direct communications, including, but not limited to, short messaging service, instant messaging, video communications, and the like.

In addition to establishing the direct communication channel, the transaction processing server 204 also transmits a transaction record to the selected shipper 210. The transaction record can include data corresponding to the selected transaction, including the data previously collected by the data processing application 414 from the buyer computing device 202 and/or the seller computing device 202. For example, a buyer may not have to submit any additional information to initiate and conclude a shipping transaction, as the data may be transmitted from previous buyer and seller entries. Alternatively, the transaction record may be transmitted via electronic mail, short message service, and the like. Further, the transaction processing server 204 may also transmit a notification, such as electronic mail, telephone message, textual page, and the like, to notify a seller of a pending transaction offer.

Referring to decision block 1304, if a direct communication method is not selected, the transaction processing server 204 transmits a transaction record to the shipper 210, as described. At block 1312, the transaction processing server 204 obtains confirmation that the transaction has been completed. In an illustrative embodiment of the present invention, the transaction processing server 204 may also obtain and store negotiation information as the party offers/counteroffers are submitted. Alternatively, the transaction processing server 204 may only obtain a notification if a transaction can be completed. At block 1314, the sub-routine returns to routine 1200.

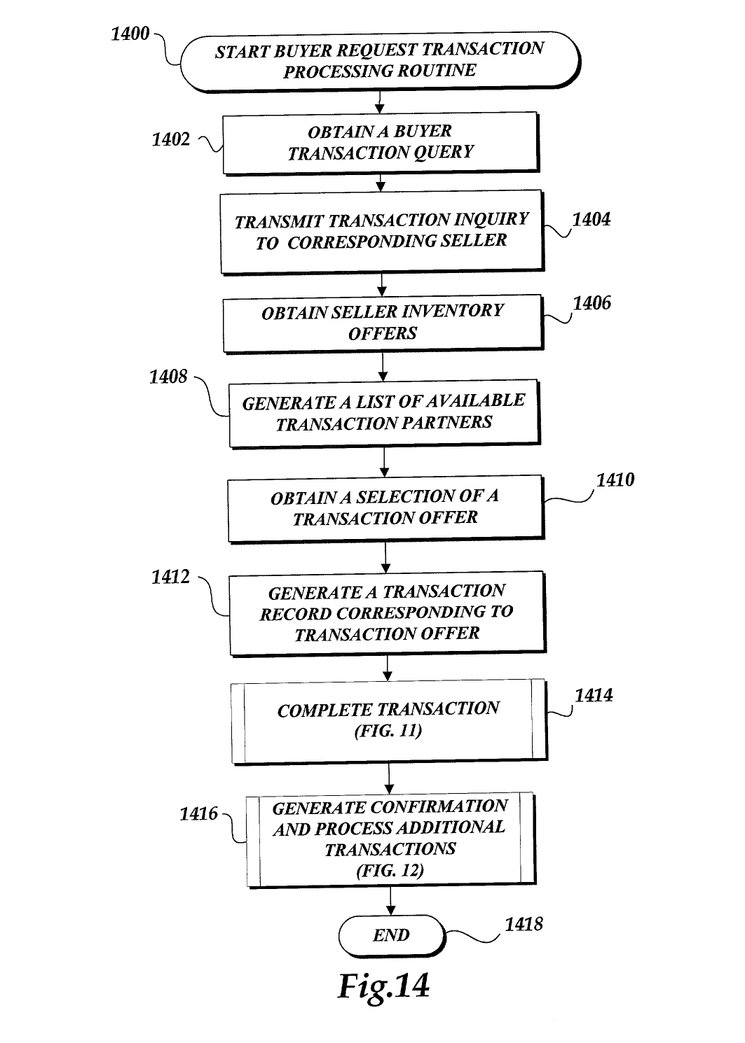

As explained above and illustrated in FIGS. 6A and 6B, in an alternative embodiment of the present invention, a buyer computing device 202 may also initiate a transaction query with one or more seller computing devices 202. FIG. 14 is a flow diagram illustrative of a routine 1400 for processing a wood product transaction involving a buyer computing device transaction query. At block 1402, the buyer interface application 410 obtains a buyer transaction query from a buyer computing device 202. In an illustrative embodiment of the present invention, the transaction processing server 204 may provide a Web page interface to allow the buyer to enter data. Alternatively, the buyer computing device 202 may transmit the transaction query via electronic mail, short message service, and the like. Additionally, the buyer computing device 202 may utilize one or more pre-configured transaction queries that are sent on a periodic basis or upon request from the buyer computing device 202.

At block 1404, the seller interface application 412 transmits the transaction query to one or more seller computing devices 202. In an illustrative embodiment of the present invention, the data processing application 414 may utilize a variety of criteria to select which seller computing devices 202 receive the transaction query. As described above with respect to block 1006 (FIG. 10), the data processing application 414 may utilize buyer/seller specified data to include/exclude particular sellers. For example, the data processing application 414 may utilize a three-tiered approach for specification of which parties to include/exclude. Additionally, the data processing application 414 may utilize correlation information to allow the buyer and the sellers to specify proprietary product/quantity information.

At block 1406, the seller interface application 412 obtains seller inventory offers specifying responding to the transaction query. At block 1408, the buyer interface application 410 transmits a list of available transaction partners to the buyer computing device 202. In an illustrative embodiment of the present invention, the data processing application 414 may also provide some additional processing to determine the proper order of the list and/or to include/exclude additional parties. At block 1410, the buyer interface application 410 obtains a selection of a transaction offer from the buyer computing device 202. In an illustrative embodiment of the present invention, the transaction offer from the buyer computing device 202 may be facilitated through the utilization of a Web page format that allows a buyer, through a browser application 312, to fill in forms. Alternatively, the offer may be transmitted via electronic mail, short message service, facsimile and the like. Additionally, in another aspect of the present invention, the transaction processing server 204 may maintain some pre-entered user data such that the buyer is not required to enter in at least some of the terms. Further, the data processing application 414 may also maintain a history of the purchasing selections that the buyer has transmitted in this session, or in previous sessions, such that the purchasing selection data is pre-entered in subsequent forms. For example, assume that the buyer has previously entered the shipping address, contact information, etc. into a buyer request form. In accordance with the present invention, the data processing application 414 may store and reuse at least some of the data for each subsequent transaction form that is required from the buyer.

At block 1412, the data processing application generates one or more transaction records corresponding to offers obtained from the buyer computing device 202. As explained above, the data processing application may import any additional data related to the buyer and/or process the buyer inputted data into a format specified by the particular selling computing device. At block 1412, the transaction processing server 204 completes the transaction. In an illustrative embodiment of the present invention, the transaction processing server 204 may complete the transaction as illustrated in routine 1100 (FIG. 11).

At block 1416, the transaction processing server 204 generates a confirmation and processes additional transactions. In an illustrative embodiment of the present invention, the transaction processing server 202 may generate the confirmation and process any additional transactions as illustrated in routines 1200 and 1300 (FIGS. 1200 and 1300). At block 1418, the routine 1400 terminates. Accordingly, a buyer computing devices 202 may initiate a wood products transaction with seller computing device 202 in a variety of manners.

In addition to the initiation of new transaction inquiries (FIG. 10) and NEW transaction queries (FIG. 14), in accordance with another aspect of the present invention, the transaction processing server 204 may also facilitate the maintenance of previously established transactions between buyers and sellers. More specifically, in an illustrative embodiment of the present invention, the transaction processing server 204 may facilitate the maintenance of seller inventory levels for one or more buyers.

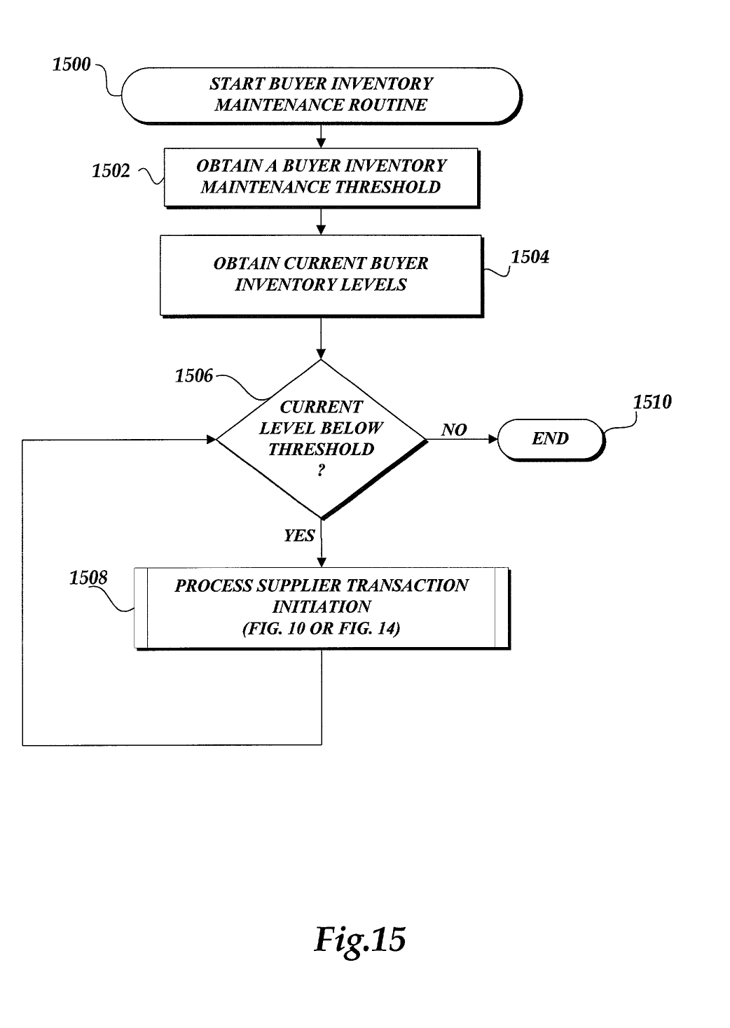

FIG. 15 is a flow diagram illustrative of a buyer inventory maintenance routine 1500 implemented by the transaction processing server 204 in accordance with the present invention. At block 1502, the transaction processing server 204 obtains a buyer inventory maintenance thresholds from a buyer computing device 202 or seller computing device 202. In an illustrative embodiment of the present invention, the buyer interface application 410 may provide a Web page interface that facilitates the specification of an inventory threshold. As previously described above, the specification of the product/quantity information may be done utilizing proprietary designators.

At block 1504, the buyer interface application 410 obtains current buyer inventory levels. In an illustrative embodiment of the present invention, the buyer interface application 410 may interface directly with the buyer computing device 202, such as with the inventory management component, to obtain the information. Alternatively, the buyer interface application 410 may poll the buyer computing device 202, such as through electronic mail, short message service, facsimile. Still further, the buyer interface application 410 may be configured to wait for the buyer computing device to report inventory levels, such as through a Web page interface.

At block 1506, a test is conducted to determine whether the buyer inventory level is below the threshold. If the buyer inventory level is not below the threshold, the routine 1500 terminates at block 1510. Alternatively, if the inventory level is below the threshold, at block 1508, the transaction processing server 204 processes a supplier order. In an illustrative embodiment of the present invention, the seller interface application 414 may have a pre-selected list of seller computing devices 202 with which to issue transaction orders. In one embodiment, the seller interface application 414 may automatically issue the transaction order. In another embodiment, the seller interface application may be required to obtain buyer acceptance prior to issuing the transaction order. In an alternative embodiment of the present invention, the transaction processing server 204 may utilize routine 1000 or routine 1400 to issue transaction inquiries or queries to a selected group of sellers to fulfill the order. Upon processing the order, the routine 1500 returns to decision block 1506 until the buyer's inventory levels exceed the threshold.

In accordance with the present invention, the transaction processing system 200 facilitates the initiation of one more transactions between two or more parties. In an exemplary embodiment of the present invention, the transaction processing system 200 facilitates various aspects of wood products transactions including transaction initiations, negotiations, and transaction processing. Accordingly, the system of the present invention may be utilized in regards to a publicly available system or to a private or semi-private network.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for facilitating transactions between one or more buyers and sellers, the method comprising:
obtaining a buyer transaction request, the transaction request including one or more buyer criteria;
identifying a set of sellers corresponding to the at least one buyer criteria;
transmitting the set of sellers corresponding to the buyer criteria;
obtaining a selection of at least one seller corresponding to the buyer criteria;
processing the negotiation of a transaction between the buyer and the selected seller corresponding to the buyer criteria;
obtaining a confirmation of the completion of a transaction between the buyer and the selected seller; and
generating transaction records associated with the completed transaction.

2. The method as recited in claim 1, wherein obtaining the buyer transaction request includes obtaining a buyer transaction inquiry from a buyer computing device, wherein the buyer transaction inquiry includes a request to identify sellers operable to sell a buyer specified product and quantity.

3. The method as recited in claim 2, wherein identifying a set of sellers corresponding to the buyer criteria includes:
obtaining product and quantity correlation data; and
translating the buyer specified product and quantity data into a format compatible with each identified seller corresponding to the buyer criteria.

4. The method as recited in claim 2, wherein identifying a set of seller corresponding to the buyer criteria includes applying selection criteria.

5. The method as recited in claim 4, wherein the selection criteria includes information selecting one or more general seller categories to include/exclude.

6. The method as recited in claim 4, wherein the selection criteria includes information identifying specific sellers to include/exclude.

7. The method as recited in claim 6, wherein the information identifying specific sellers to include/exclude is obtained from the buyer computing device.

8. The method as recited in claim 6, wherein the information identifying specific sellers to include/exclude is obtained from a seller computing device.

9. The method as recited in claim 4, wherein the selection criteria includes information identifying one or more general seller categories to include/exclude and one or more specific sellers corresponding to the general seller categories to include/exclude.

10. The method as recited in claim 2, wherein obtaining the buyer transaction request includes obtaining a buyer transaction query from a buyer computing device, wherein the buyer transaction query includes an invitation for offers from a number of sellers.

11. The method as recited in claim 7, wherein identifying a set of sellers corresponding to the buyer criteria includes:
identifying a set of sellers corresponding to the buyer criteria;
transmitting the transaction query to the set of sellers; and
obtaining one or more seller offers corresponding to the transaction query.

12. The method as recited in claim 8, wherein identifying a set of seller corresponding to the buyer criteria includes applying selection criteria.

13. The method as recited in claim 8, wherein the selection criteria includes information selecting one or more general seller categories to include/exclude from the transaction query.

14. The method as recited in claim 8, wherein the selection criteria includes information identifying specific sellers to include/exclude from the transaction query.

15. The method as recited in claim 14, wherein the information identifying specific sellers to include/exclude is obtained from the buyer computing device.

16. The method as recited in claim 14, wherein the information identifying specific sellers to include/exclude is obtained from a seller computing device.

17. The method as recited in claim 8, wherein the selection criteria includes information identifying one or more general seller categories to include/exclude and one or more specific sellers corresponding to the general seller categories to include/exclude.

18. The method as recited in claim 1, wherein obtaining a selection of at least one seller corresponding to the buyer criteria includes:
generating a Web page interface; and
obtaining a selection of the at least one seller via the Web page interface.

19. The method as recited in claim 1, wherein processing the negotiation of a transaction includes:
obtaining communications from the buyer; and
transmitting the communications to the selected seller.

20. The method as recited in claim 1, wherein processing the negotiation of a transaction includes:
obtaining communications from the selected seller; and
transmitting the communications to the buyer.

21. The method as recited in claim 1, wherein processing the negotiation of a transaction includes:
obtaining a selection of a direction communication method between the buyer and the selected seller; and
establishing the direct communication channel between the buyer and the selected seller.

22. The method as recited in claim 21, wherein the direct communication channel includes an Internet voice communication channel.

23. The method as recited in claim 21, wherein the direct communication method includes a standard telephonic communication channel.

24. The method as recited in claim 1 further comprising:
obtaining a third party transaction request;
identifying one or more third parties corresponding to third party transaction request;
transmitting a set of third parties corresponding to the third party transaction request;
obtaining a selection of at least one third party corresponding to the third party transaction request;
processing the negotiation of a transaction with the selected third party corresponding to the third party transaction request;
obtaining a confirmation of the completion of a transaction with the selected third party corresponding to the third party transaction request; and
generating transaction records associated with the completed transaction.

25. The method as recited in claim 24, wherein the third party is a third party shipper, and wherein the third party transaction request includes a shipping transaction request.

26. The method as recited in claim 24, wherein the third party is a third party insurance agent, and wherein the third party transaction request includes an insurance transaction request.

27. The method as recited in claim 24, wherein the transaction request is obtained from the buyer.

28. The method as recited in claim 24, wherein the transaction request is obtained from the selected seller.

29. The method as recited in claim 1, wherein the transaction request is a wood products transaction request.

30. A computer-readable medium having computer-executable instruction for performing the method recited in claim 1.

31. A computer system having a processor, a memory, and an operating environment, the computer system operable to perform the method recited in claim 1.

32. In a computer system having a transaction processing server in communication with at least one buyer computing device and one seller computing device, a method for facilitating transactions between a buyer computing device and a seller computing device, the method comprising:
obtaining a buyer transaction request from a buyer computing device, the transaction request including one or more buyer criteria;
identifying a set of sellers corresponding to the at least one buyer criteria;
transmitting the set of sellers corresponding to the buyer criteria to the buyer computing device;
obtaining a selection of at least one seller corresponding to the buyer criteria from the buyer computing device;
processing the negotiation of a transaction between the buyer computing device and one or more seller computing devices corresponding to the selected seller;
obtaining a confirmation of the completion of a transaction between the buyer and the selected seller;
obtaining a third party transaction request;
identifying one or more third parties corresponding to third party transaction request;
transmitting a set of third parties corresponding to the third party transaction request;
obtaining a selection of at least one third party corresponding to the third party transaction request;
processing the negotiation of a transaction with the selected third party corresponding to the third party transaction request;
obtaining a confirmation of the completion of a transaction with the selected third party corresponding to the third party transaction request; and
generating transaction records associated with the completed transaction.

33. The method as recited in claim 32, wherein the buyer transaction inquiry includes a request to identify sellers operable to sell a buyer specified product and quantity.

34. The method as recited in claim 33, wherein identifying a set of sellers corresponding to the buyer criteria includes:
obtaining product and quantity correlation data; and
translating the buyer specified product and quantity data into a format compatible with each identified seller corresponding to the buyer criteria.

35. The method as recited in claim 33, wherein identifying a set of seller corresponding to the buyer criteria includes applying selection criteria.

36. The method as recited in claim 35, wherein the selection criteria includes information selecting one or more general seller categories to include/exclude.

37. The method as recited in claim 35, wherein the selection criteria includes information identifying specific sellers to include/exclude.

38. The method as recited in claim 37, wherein the information identifying specific sellers to include/exclude is obtained from the buyer computing device.

39. The method as recited in claim 37, wherein the information identifying specific sellers to include/exclude is obtained from a seller computing device.

40. The method as recited in claim 35, wherein the selection criteria includes information identifying one or more general seller categories to include/exclude and one or more specific sellers corresponding to the general seller categories to include/exclude.

41. The method as recited in claim 33, wherein obtaining the buyer transaction request includes obtaining a buyer transaction query from a buyer computing device, wherein the buyer transaction query includes an invitation for offers from a number of sellers.

42. The method as recited in claim 38, wherein identifying a set of sellers corresponding to the buyer criteria includes:
identifying a set of sellers corresponding to the buyer criteria;
transmitting the transaction query to the set of sellers; and
obtaining one or more seller offers corresponding to the transaction query.

43. The method as recited in claim 39, wherein identifying a set of seller corresponding to the buyer criteria includes applying selection criteria.

44. The method as recited in claim 39, wherein the selection criteria includes information selecting one or more general seller categories to include/exclude from the transaction query.

45. The method as recited in claim 39, wherein the selection criteria includes information identifying specific sellers to include/exclude from the transaction query.

46. The method as recited in claim 45, wherein the information identifying specific sellers to include/exclude is obtained from the buyer computing device.

47. The method as recited in claim 45, wherein the information identifying specific sellers to include/exclude is obtained from a seller computing device.

48. The method as recited in claim 39, wherein the selection criteria includes information identifying one or more general seller categories to include/exclude and one or more specific sellers corresponding to the general seller categories to include/exclude.

49. The method as recited in claim 32, wherein obtaining a selection of at least one seller corresponding to the buyer criteria includes:
generating a Web page interface; and
obtaining a selection of the at least one seller via the Web page interface.

50. The method as recited in claim 32, wherein processing the negotiation of a transaction includes:
obtaining communications from the buyer; and
transmitting the communications to the selected seller.

51. The method as recited in claim 32, wherein processing the negotiation of a transaction includes:
obtaining communications from the selected seller; and
transmitting the communications to the buyer.

52. The method as recited in claim 32, wherein processing the negotiation of a transaction includes:
obtaining a selection of a direction communication method between the buyer and the selected seller; and
establishing the direct communication channel between the buyer and the selected seller.

53. The method as recited in claim 52, wherein the direct communication channel includes an Internet voice communication channel.

54. The method as recited in claim 52, wherein the direct communication method includes a standard telephonic communication channel.

55. The method as recited in claim 32, wherein the transaction request is a wood products transaction request.

56. A computer-readable medium having computer-executable instruction for performing the method recited in claim 32.

57. A computer system having a processor, a memory, and an operating environment, the computer system operable to perform the method recited in claim 32.

58. A method for facilitating transactions between buyers and sellers, the method comprising:
obtaining a buyer transaction request, the buyer transaction request including one or more buyer criteria and a buyer inventory threshold;
obtaining current buyer inventory status data;
determining whether the current buyer inventory status data is below the buyer inventory threshold; and
processing a buyer and seller transaction if the current buyer inventory status data is below the buyer inventory threshold.

59. The method as recited in claim 58, wherein obtaining current buyer inventory status data includes polling a buyer computing device for the buyer inventory status data on a periodic bases.

60. The method as recited in claim 58, wherein obtaining current buyer inventory status data includes receiving the buyer inventory status data from a buyer computing device on a periodic basis.

61. The method as recited in claim 58, wherein processing a buyer and seller transaction includes:
identifying a set of sellers corresponding to the at least one buyer criteria;
transmitting the set of sellers corresponding to the buyer criteria;
obtaining a selection of at least one seller corresponding to the buyer criteria; and
processing the negotiation of a transaction between the buyer and the selected seller corresponding to the buyer criteria.

62. The method as recited in claim 61, wherein obtaining the buyer transaction request includes obtaining a buyer transaction inquiry from a buyer computing device, wherein the buyer transaction inquiry includes a request to identify sellers operable to sell a buyer specified product and quantity.

63. The method as recited in claim 61, wherein identifying a set of sellers corresponding to the buyer criteria includes:
identifying a set of sellers corresponding to the buyer criteria;
transmitting the transaction query to the set of sellers; and
obtaining one or more seller offers corresponding to the transaction query.

64. The method as recited in claim 61, wherein identifying a set of seller corresponding to the buyer criteria includes automatically initiating a transaction with at least one identified seller corresponding to the buyer criteria.

65. The method as recited in claim 61, wherein the transaction request is a wood products transaction request.

66. A computer-readable medium having computer-executable instruction for performing the method recited in claim 58.

67. A computer system having a processor, a memory, and an operating environment, the computer system operable to perform the method recited in claim 58.
